(19) United States
(12) Patent Application Publication
(10) Pub. No.: US 2014/0260949 A1
(43) Pub. Date: Sep. 18, 2014

(54) DOUBLE SERVICE CHAMBER PNEUMATIC ACTUATOR

(71) Applicant: TSE Brakes, Inc., Cullman, AL (US)

(72) Inventors: KoK Ho, Cullman, AL (US); Richard Conaway, Muskegon, MI (US)

(73) Assignee: TSE Brakes, Inc., Cullman, AL (US)

(21) Appl. No.: 14/213,391

(22) Filed: Mar. 14, 2014

Related U.S. Application Data
(60) Provisional application No. 61/791,107, filed on Mar. 15, 2013.

(51) Int. Cl. F15B 15/02

(52) U.S. Cl. CPC F15B 15/02
USPC 91/368

(57) ABSTRACT

A pneumatic actuator has a first service chamber assembly featuring a first housing defining a first chamber and a second service chamber assembly featuring a second housing defining a second chamber. A first diaphragm divides the first chamber into a first pressurized air side and a first spring side while a second diaphragm divides the second chamber into a second pressurized air side and a second spring side. An actuator rod extends out of the second housing. A connecting actuator rod is connected to the actuator rod and the first diaphragm. Pressurized air inlet ports are in communication with the first and second pressurized air sides of the first and second chambers respectively. The first and second diaphragms cooperating to further extend the distal end of the actuator rod away from the second housing into an extended position when pressurized air is introduced into the first and second pressurized air sides of the first and second chambers.

### BACKGROUND

This application claims priority to provisional patent application No. 61/791,107, filed Mar. 15, 2013, currently pending, the contents of which are hereby incorporated by reference.

### FIELD OF THE INVENTION

The present invention relates generally to pneumatic actuators for use on equipment and, more specifically, to a double service chamber pneumatic actuator for use on a heavy equipment.

### BACKGROUND

Pneumatic actuators convert air pressure to linear force to achieve actuation. They find use in several industries including, but not limited to, the heavy vehicle industry. One type of pneumatic actuator is a pneumatic brake chamber, such as the one illustrated in U.S. Pat. No. 5,829,339 to Smith. Such pneumatic actuators are commonly used for a variety of applications in the heavy vehicle industry, such as vehicle brake actuation, lift axle actuation, and lift gate actuation.

Generally the actuation force of a pneumatic actuator is dependent on two variables—namely the pressure used and the affective area over which the pressure acts. For a given pressure, the greater the area, the larger the force generated. Because in practice these chambers are roughly cylindrical in shape and the pressure available is fixed, the available force is essentially determined by the diameter of the chamber.

A problem often encountered in vehicle applications is that the actuation force desired is limited by the space available. That is, only a certain sized chamber can fit in the allotted space, but the actuation force desired is greater than can be provided by the chamber that can fit. Use of pneumatic actuators to power axle lifting devices presents an example of an application where limited space is available for the pneumatic actuator. More specifically, it is a common practice to lift an axle of a heavy vehicle, such as a refuse truck, logging truck, cement mixer, dump truck or a semi-trailer, when a heavy load is not being carried by the vehicle. Such a practice improves maneuverability of the unloaded vehicle and saves wear and tear on the axle, wheels and tires and improves fuel economy.

A need therefore exists for a pneumatic actuator and method that addresses the above issues.

### BRIEF DESCRIPTION OF THE DRAWINGS

FIG. 1 is a cross sectional view of an embodiment of the pneumatic actuator of the present invention with the actuator rod in the retracted position;

FIG. 2 is a cross sectional view of the pneumatic actuator of FIG. 1 with the actuator rod in the extended position;

FIG. 3 is a front perspective view of the pneumatic actuator of FIG. 2;

FIG. 4 is a rear perspective view of the pneumatic actuator of FIGS. 2 and 3;

FIG. 5 is a side elevational view of an axle lifting device within which the pneumatic actuator of FIGS. 1-4 may be used.

### DETAILED DESCRIPTION OF EMBODIMENTS

An embodiment of the pneumatic actuator of the present invention is indicated in general at 10 in FIGS. 1-4. The actuator includes a first service chamber assembly, indicated in general at 12, and a second service chamber assembly, indicated in general at 14, that are connected together, as will be explained in greater detail below.

First service chamber assembly 12 includes a first housing having an outer shell 16 and an inner shell 18, while second service chamber assembly 14 similarly includes a second housing having an outer shell 22 and an inner shell 24. The outer and inner shells of the first service chamber assembly are circumferentially joined so as to define a first chamber 25. A first diaphragm 26 is positioned within the first chamber and features a circumferential lip portion 28 that is received within the annular space defined between the circumferential ledge 32 of the inner shell 18 and the circumferential channel portion 34 of the outer shell 16. The outer and inner shells of the second service chamber assembly 14 similarly define a second chamber 35 within which a second diaphragm 36 is positioned and secured in a similar fashion. First and second diaphragms 26 and 36 are preferably made from high-strength rubber, or any other elastic material known in the art for constructing service chamber or actuator diaphragms.

An actuator rod 42 is positioned within the second chamber 35 and has a distal end portion that exits an opening formed in the end plate 44 of the second service chamber assembly 14. A disc-shaped second diaphragm plate 46 is secured to the proximal end of the actuator rod. The diaphragm plate 46 may be integrally formed with the actuator rod 42, or the two pieces may be formed separately and then joined during assembly of the device. A central portion of the second diaphragm 36 is secured to the second diaphragm plate 46, preferably with adhesive or the like.

A connecting actuator rod 52 is positioned within the first chamber 25 and features a distal end that passes through an opening formed in a central portion of the outer shell 22 of the second service chamber assembly. A disc-shaped stop plate 54 is secured to the distal end of the connecting actuator rod 52 by fastener 56 with the stop plate 54 being positioned in the second chamber 35. A disc-shaped first diaphragm plate 60 is secured to the proximal end of the connecting actuator rod 52 by fastener 62. A central portion of the first diaphragm 26 is secured to the first diaphragm plate 60, preferably with adhesive or the like.

FIG. 1 illustrates the pneumatic actuator 10 in the unpressurized condition with the actuator rod in a retracted position. A first compression coil spring 64 is positioned within the first chamber and engages the first diaphragm plate 60 and urges it into the position shown in FIG. 1. The opposite end of the coil spring is provided with a spacer 66 which limits compression of the coil spring when the device is pressurized. A second compression coil spring 68 is similarly positioned within the second chamber and urges the second diaphragm plate 46 into the position illustrated in FIG. 1.

The actuator is preferably provided with mounting bolts 72a and 72b and the distal end of actuator rod 42 is preferably provided with threads 74 so that the actuator may be mounted to a use device or mechanism, an example of which is provided below.

The first diaphragm 26 divides the first chamber 25 in to a first pressurized air side 75 and a first spring side 76. The second diaphragm 36 similarly divides the second chamber 35 into a second pressurized air side 77 and a second spring side 78. As illustrated in FIGS. 1-4, the first service chamber assembly 12 is provided with first air inlet port 80, which communicates with the first pressurized air side 75 of the first chamber 25. The second service chamber assembly features a second air inlet port 82 which communicates with the second pressurized air side 77 of the second chamber 35. As illustrated in FIGS. 3 and 4, the first service chamber assembly also features an air exhaust port 84 that communicates with the first spring side 76 of the first chamber. Air exhaust openings, illustrated at 86 in FIGS. 1-4 communicate with the second spring side 78 of the second chamber.

Actuator rod 42 and connecting actuator rod 52 may optionally be constructed as a single component.

As a result of the above construction, the actuator rod 42 is connected to both diaphragms (26, 36) and extends out of one side of the second service chamber assembly. To further extend the actuator rod 42 out of the chamber into the extended position illustrated in FIG. 2, pressurized air is introduced into the pressurized air sides 75 and 77 of both the first and second chambers through air inlet ports 80 and 82 so that the first and second diaphragms cooperate to move into the positions illustrated in FIGS. 2 against the urging of first and second coils springs 64 and 68. As this occurs, air exists the first and second spring side chambers 76 and 78 through exhaust port 84 and exhaust openings 86, respectively. As a result, the actuator rod 42 is extended into the extended position illustrated in FIG. 2. To retract the actuator rod 42, the air pressure is relieved, so that air exits the first and second pressurized air chambers through ports 80 and 82, respectively, and the springs in each chamber force the actuator rod back to its original retracted position illustrated in FIG. 1.

As noted previously, the solution to increasing the actuation force of a pneumatic actuator lies in either raising the available pressure or increasing the effective area (the size) of the chamber. The above embodiment of the invention takes the second approach, obviating the need for the first. That is, the pneumatic actuator of the invention increases the effective area without increasing the diameter is by adding another service chamber in series with the first. The approach allows essentially double the force for a given diameter. The above embodiment does so at the cost of extra length. In many applications, however, length constraints are not significant, whereas diameter constraints are considerable.

An example of an axle lift assembly within which the pneumatic actuator of the invention may be used is provided in FIG. 5 from U.S. Pat. No. 7,854,436 to Hock et al., the contents of which are hereby incorporated by reference. With reference to FIG. 5, a supporting element 102 is indirectly supported on the frame element 116 of the vehicle via a lever member 130. This essentially results in the configuration of a toggle lever. The lever member 130 has an articulated or pivotable or rotatable connection to the supporting element 102 via a first lever member bearing region 132. The first lever member bearing region 132 is mounted on the supporting element 102 in such a way that the former is advantageously separated at a distance from the supporting element bearing region 108 and from the region of the supporting element 102 on which the lifting element 104, which may be the pneumatic actuator 10 of FIGS. 1-4 with the actuator rod 42 attached to lever element 106, is mounted. In addition, the lever member 130 is mounted on the frame element 116 of the vehicle in an articulated or pivotable or rotatable manner via a second lever member bearing region 134. When the lifting element 104 (10 of FIGS. 1-4) is actuated, in the manner described above, and the supporting element 102 and lever element 106 are correspondingly moved or rotated by the lever member 30, this results in an improved servo effect, thereby increasing the effectiveness of the axle lifting device. The pneumatic actuator of the invention may be used with alternative axle lift assemblies, devices and mechanisms, and the axle lift assembly of FIG. 5 is presented as an example only.

While the preferred embodiments of the invention have been shown and described, it will be apparent to those skilled in the art that changes and modifications may be made therein without departing from the spirit of the invention, the scope of which is defined by the appended claims.

What is claimed is:

1. A pneumatic actuator comprising:
a) a first service chamber assembly featuring a first housing defining a first chamber;
b) a second service chamber assembly featuring a second housing defining a second chamber;
c) a first diaphragm dividing the first chamber into a first pressurized air side and a first spring side;
d) a second diaphragm dividing the second chamber into a second pressurized air side and a second spring side;
e) an actuator rod having a proximal end attached to the second diaphragm and a distal end extending out of the second housing in a retracted position;
f) a connecting actuator rod having a distal end connected to the proximal end of the actuator rod and a proximal end connected to the first diaphragm;
g) first and second pressurized air inlet ports in communication with the first and second pressurized air sides of the first and second chambers respectively; and
h) said first and second diaphragms cooperating to further extend the distal end of the actuator rod away from the second housing into an extended position when pressurized air is introduced into the first and second pressurized air sides of the first and second chambers.

2. The pneumatic actuator of claim 1 wherein the actuator rod and the connecting actuator rod are constructed as a single component.

3. The pneumatic actuator of claim 1 further comprising:
i) a first compression spring positioned in the first spring side of the first chamber and engaging the first diaphragm;
j) a second compression spring positioned in the second spring side of the second chamber and engaging the second diaphragm; and
k) said first and second compression springs urging the first and second diaphragms in a direction whereby the actuator rod is moved into the retracted position.

4. The pneumatic actuator of claim 3 wherein the first and second compression springs are coil springs.

5. The pneumatic actuator of claim 1 further comprising exhaust ports formed in the first and second housing, said exhaust ports in communication with the first and second spring sides of the first and second chambers.

6. The pneumatic actuator of claim 1 further comprising mounting bolts attached to the first or second housings.

7. The pneumatic actuator of claim 1 wherein the actuator rod and the connecting actuator rod are individual components that are joined.

8. The pneumatic actuator of claim 1 further comprising a stop plate connected to the distal end of the connecting actuator rod.

9. The pneumatic actuator of claim 1 further comprising a second diaphragm plate attached to the proximal end portion of the actuator rod.

10. The pneumatic actuator of claim 1 further comprising a first diaphragm plate attached to the proximal end portion of the connecting actuator rod.

11. An axle lift mechanism for a vehicle having a frame and an axle comprising:
a) a pneumatic actuator adapted to be mounted to the frame of the vehicle;
b) said pneumatic actuator including:
i. a first service chamber assembly featuring a first housing defining a first chamber;
ii. a second service chamber assembly featuring a second housing defining a second chamber;
iii. a first diaphragm dividing the first chamber into a first pressurized air side and a first spring side;
iv. a second diaphragm dividing the second chamber into a second pressurized air side and a second spring side;
v. an actuator rod having a proximal end attached to the second diaphragm and a distal end extending out of the second housing in a retracted position, said actuator rod adapted to be attached to the axle of the vehicle;
vi. a connecting actuator rod having a distal end connected to the proximal end of the actuator rod and a proximal end connected to the first diaphragm;
vii. first and second pressurized air inlet ports in communication with the first and second pressurized air sides of the first and second chambers respectively;
viii. said first and second diaphragms cooperating to further extend the distal end of the actuator rod away from the second housing into an extended position when pressurized air is introduced into the first and second pressurized air sides of the first and second chambers.

12. The axle lift mechanism of claim 11 wherein the actuator rod and the connecting actuator rod are constructed as a single component.

13. The axle lift mechanism of claim 11 further comprising:
ix. a first compression spring positioned in the first spring side of the first chamber and engaging the first diaphragm;
x. a second compression spring positioned in the second spring side of the second chamber and engaging the second diaphragm; and
xi. said first and second compression springs urging the first and second diaphragms in a direction whereby the actuator rod is moved into the retracted position.

14. The axle lift mechanism of claim 13 wherein the first and second compression springs are coil springs.

15. The axle lift mechanism of claim 11 further comprising exhaust ports formed in the first and second housing, said exhaust ports in communication with the first and second spring sides of the first and second chambers.

16. The axle lift mechanism of claim 11 further comprising mounting bolts attached to the first or second housings.

17. The axle lift mechanism of claim 11 wherein the actuator rod and the connecting actuator rod are individual components that are joined.

18. The axle lift mechanism of claim 11 further comprising a stop plate connected to the distal end of the connecting actuator rod.

19. The axle lift mechanism of claim 11 further comprising a second diaphragm plate attached to the proximal end portion of the actuator rod.

20. The axle lift mechanism of claim 11 further comprising a first diaphragm plate attached to the proximal end portion of the connecting actuator rod.
